(19) United States
(12) Patent Application Publication
(10) Pub. No.: US 2024/0392053 A1
(43) Pub. Date: Nov. 28, 2024

(54) THERMOSETTING COMPOSITIONS BASED ON (METH)ACRYLATES AND PEROXODICARBONATES

(71) Applicant: DELO Industrie Klebstoffe GmbH & Co. KGaA, Windach (DE)

(72) Inventors: Marko BRIEM, Windach (DE); Katharina MAIER, Windach (DE)

(21) Appl. No.: 18/688,027

(22) PCT Filed: Jul. 26, 2022
(86) PCT No.: PCT/EP2022/070914

§ 371 Date: Feb. 29, 2024

(30) Foreign Application Priority Data
Sep. 3, 2021 (DE) 10 2021 122 835.2

(51) Int. Cl. C08F 220/18; C08K 3/04; C08K 5/13; C08L 33/06; C08L 67/06; C08L 75/14; C09D 4/06; C09D 7/61; C09D 7/63; C09D 133/06; C09D 167/06; C09D 175/14; C09J 4/06; C09J 5/06; C09J 11/04; C09J 11/06; C09J 133/06; C09J 167/06; C09J 175/14

(52) U.S. Cl. CPC C08F 220/1811; C08K 3/04; C08K 5/13; C08L 33/064; C08L 67/06; C08L 75/14; C09D 4/06; C09D 7/61; C09D 7/63; C09D 133/064; C09D 167/06; C09D 175/14; C09J 4/06; C09J 5/06; C09J 11/04; C09J 11/06; C09J 133/064; C09J 167/06; C09J 175/14; C08L 2201/08; C08L 2203/30

(57) ABSTRACT

Example embodiments relate to a thermosetting composition, wherein the composition comprises the following components: (A) at least one radically curable compound, with the radically curable compound comprising at least one (meth)acrylate, (B) at least one radical initiator based on a peroxo compound, with the peroxo compound comprising at least one peroxodicarbonate, (C) at least one stabilizer comprising at least one sterically hindered phenol, and (D) at least one synergist based on a carbon modification having unsaturated carbon-carbon bonds.

### FIELD OF THE DISCLOSURE

The present disclosure relates to a thermosetting composition based on (meth)acrylates and peroxodicarbonates. In addition, the present disclosure relates to the use of the composition as a sealing, adhesive and/or encapsulant composition.

### BACKGROUND

In the state of the art, various peroxides are known which are used as an initiator for the radical polymerization of compositions based on ethylenically unsaturated compounds.

Common peroxo compounds comprise peroxo(di)esters, hydroperoxides, (di)alkyl peroxides, ketone peroxides, perketals, peracids, peroxomonocarbonates and peroxodicarbonates. An overview of the peroxo compounds suitable as initiators and their thermal properties such as in particular the 1-hour half-life temperatures can be found in the brochure “Polymerization of monomers with Organic Peroxides for the High Polymer Industry” from the company Pergan, accessible under https://www.pergan.com/files/downloads/Polymerization_of_monomers.pdf.

A 1-hour half-life temperature is a temperature at which half of a given amount of peroxide disintegrates within one hour. Typically, the half-life temperature of peroxide is determined in a 0.1 molar solution in monochlorobenzene. Accordingly, a half-life is the time in which half of a given amount of peroxide disintegrates at a certain temperature.

The peroxo compounds mentioned vary widely in terms of their reactivity. For example, most hydroperoxides can be easily stored at room temperature for months, while many peroxodicarbonates have a 1-hour half-life temperature of approx. 60° C. and cannot be stored permanently at room temperature.

EP 0 245 728 A2 discloses a method for producing scratch resistant coatings in which (meth)acrylate-containing formulations are thermally polymerized using a peroxide having a half-life of less than 2 minutes at 100° C. In particular, the use of dialkyl peroxodicarbonates is described as advantageous as they can be activated at low temperatures and the coatings cured with them have a high scratch resistance. The use of stabilizers is not disclosed in the specification. The formulations described have a short processing time at room temperature and can only be stored for a limited time even at low temperatures.

In WO 2018/089494 A1 both thermosetting and dual-curing (meth)acrylate systems are described. They are characterized by low curing temperatures of 80° C. or less while having a high glass transition temperature of 85° C. or more in the cured state. The high reactivity is achieved by using aliphatic peroxodicarbonates. However, the compositions described have an insufficient stability at room temperature, which can be adverse and expensive in industrial processes during downtimes, in particular when using large adhesive containers. After correspondingly long holdup times at room temperature the compositions tend to cure partially and can thus not be dosed in a process-safe way.

Approaches to stabilize the particularly reactive peroxodicarbonates are described in U.S. Pat. No. 5,155,192 A. To this end, small amounts of hydroperoxides are added to peroxodicarbonates. However, the use of a reactive (meth)acrylate formulation is not described. It is shown that the addition of hydroperoxides reduces the reactivity of peroxodicarbonates.

U.S. Pat. No. 5,548,046 describes the stabilization of dialkyl peroxodicarbonates with methacrylonitrile in the context of the production of PVC.

US 2004/0211938 A1 describes the stabilization of peroxodicarbonates by adding propiolic acids. Curable formulations based on (meth)acrylates are not disclosed.

A comprehensive description of further approaches to stabilize peroxodicarbonates is disclosed in WO 2003/002527 A1.

U.S. Pat. No. 10,982,120 B2 describes electrically conductive compositions containing, apart from electrically conductive particles, at least one organometal complex that has a positive effect on the contact resistance of the cured composition. As an initiator system for (meth)acrylate resins peroxodicarbonates which are additionally stabilized by a hindered phenol are described. Unfilled systems are not provided.

A variety of formulations described in the state of the art aims exclusively at the stabilization of peroxodicarbonates. In all of these descriptions, a storage stability of the peroxodicarbonate-containing compositions that is as high as possible is paramount. However, complex compositions are not disclosed. The reason for this is that the stabilized peroxides are often used for the large-scale polymerization of common monomers such as ethene, propene or vinyl chloride. In these processes, a long processing time at room temperature or an onset temperature that is as low as possible is not important.

### SUMMARY

It is an object of the disclosure to avoid the disadvantages of the compositions known from the state of the art and to provide compositions based on (meth)acrylates and peroxodicarbonates that can also be used in complex industrial processes as sealing, adhesive and/or encapsulant compositions.

Advantageous embodiments of the composition according to the present disclosure are stated in the subclaims, which, optionally, can be combined with each other.

According to the present disclosure, the thermosetting composition comprises the following components:
(A) at least one radically polymerizable compound, wherein the radically polymerizable compound comprises at least one (meth)acrylate,
(B) at least one radical initiator based on a peroxo compound, wherein the peroxo compound comprises at least one peroxodicarbonate,
(C) at least one stabilizer comprising at least one sterically hindered phenol, and
(D) at least one synergist based on a carbon allotrope having unsaturated carbon-carbon bonds.

The compositions according to the present disclosure are liquid at room temperature and are preferably present as single-component compositions. However, the compositions can also be provided in a multi-component form.

The liquid compositions are characterized by a high reactivity and, at the same time, a long processing time at room temperature. Due to the long processing time at room temperature the compositions can also be easily used in complex industrial processes, even after prolonged downtimes. In particular, the compositions, even at prolonged dosing breaks, do not have to be removed from the plant and transferred to a cold storage cell.

By exposing to heat, the compositions according to the present disclosure can be cured even at low temperatures. Optionally, the compositions can be additionally fixed by exposure to actinic radiation.

Another object of the present disclosure is the use of the composition as a sealing, adhesive and/or encapsulant composition.

Additionally, a method using the compositions for the joining, encapsulating or coating of substrates is disclosed. The method comprises the following steps:
a) providing the composition according to the present invention;
b) dosing the composition onto a first substrate;
c) optionally feeding a second substrate to the composition;
d) optionally fixing the composition by irradiation with actinic radiation; and
e) heating the composition to a temperature of 60 to 100° C. for 5 to 60 minutes while curing the composition.

### BRIEF DESCRIPTION OF THE DRAWING

FIG. 1 presents the DSC curves of compositions not according to the present invention and of a composition according to the present disclosure.

### DETAIL DESCRIPTION OF EXAMPLE EMBODIMENTS

Below, the present disclosure will be described in detail and exemplarily by means of preferred embodiments which, however, are not to be construed as limiting.

In the sense of the present disclosure, “liquid” means that at 23° C. the loss modulus G″ determined by measuring the viscosity is larger than the storage modulus G′ of the respective composition.

As far as the indefinite article “a” or “an” is used, this also comprises the plural form “one or more” if this is not explicitly excluded.

“At least bifunctional” means that two or more units of each functional group mentioned is contained per molecule.

In the sense of the present disclosure, “single-component” or “single-component composition” means that the components of the composition mentioned are present together in a common packaging unit, that is they are not stored separately.

“Multi-component” or “multi-component composition” means that the reactive components of the composition are present separately in two or more packaging units.

The compositions are considered as “processable” if the viscosity of each readily mixed composition is increased by less than 30% during storage at room temperature for a period of at least 72 hours.

Below, each component of the composition according to the present disclosure will be described separately. However, the individual components can be combined with each other in any way.

### Component (A): Radically Polymerizable Compound

The compositions contain at least one radically polymerizable compound (A) comprising at least one (meth)acrylate. In the sense of the present disclosure, the term “(meth)acrylate” comprises both acrylates and the analogous methacrylates.

In terms of structure, the (meth)acrylates of component (A) are not further restricted, comprising for example linear, branched, aliphatic, aromatic and heterocyclic (meth)acrylates and combinations thereof.

In addition, in the sense of the present disclosure, (meth)acrylates are monomeric, oligomeric or polymeric compounds as long as they contain at least one radically crosslinkable (meth)acrylate group.

In one embodiment, the radically curable compound (A) can comprise one or several monofunctional (meth)acrylates.

Examples of monofunctional aliphatic (meth)acrylates are isobutyl (meth)acrylate, isooctyl (meth)acrylate, isodecyl (meth)acrylate, lauryl (meth)acrylate, isononyl (meth)acrylate, ethylhexyl (meth)acrylate, 2-propylheptyl (meth)acrylate, 4-methyl-2-propylhexyl (meth)acrylate pentadecyl (meth)acrylate, cetyl (meth)acrylate, 2-hydroxyethyl (meth)acrylate, 4-hydroxybutyl (meth)acrylate, 2-hydroxy-3-phenoxypropyl (meth)acrylate, 2-hydroxypropyl (meth)acrylate, palmitolyl (meth)acrylate, heptadecyl (meth)acrylate and stearyl (meth)acrylate.

Examples of monofunctional cycloaliphatic (meth)acrylates are cyclohexyl (meth)acrylate, isobornyl (meth)acrylate, cyclic trimethylolpropane formyl (meth)acrylate, dicyclopentenyl (meth)acrylate, dicyclopentenyloxyethyl (meth)acrylate, dicyclopentanyl (meth)acrylate, 4-tert-butylcyclohexyl (meth)acrylate, 3,3,5-trimethylcyclohexyl (meth)acrylate, tert-butylcyclohexanol methacrylate and octahydro-4,7-methano-1H-indenylmethyl (meth)acrylate.

Examples of monofunctional aromatic (meth)acrylates are 2-(o-phenylphenoxy)ethyl (meth)acrylate, 2-(o-phenoxy)ethyl (meth)acrylate, ortho-phenylbenzyl (meth)acrylate, ethoxylated nonylphenol (meth)acrylate and ethoxyphenyl acrylate.

Examples of heterocyclic, ethoxylated and further monofunctional meth(acrylates) are tetrahydrofurfuryl (meth)acrylate, (2-ethyl-2-methyl-1,3-dioxolat-4-yl)methyl acrylate, 5-ethyl-1,3-dioxan-5-yl)methyl acrylate, caprolacton (meth)acrylate, 2-(2-ethoxyethoxy)ethyl (meth)acrylate and alkoxylated lauryl acrylate.

Apart from the monofunctional (meth)acrylates, component (A) can preferably comprise also bifunctional (meth)acrylates or (meth)acrylates of a higher functionality as a crosslinker.

Examples of bifunctional (meth)acrylates or (meth)acrylates of a higher functionality are hexanediol di(meth)acrylate, di(trimethylpropane) tetraacrylate, 4-butanediol di(meth)acrylate, tripropyleneglycol di(meth)acrylate, triethyleneglycol di(meth)acrylate, polyethyleneglycol di(meth)acrylates, 1,10-decanediol di(meth)acrylate, tricyclodecane dimethanol di(meth)acrylate, cyclohexane dimethylol di(meth)acrylate, nonanediol di(meth)acrylate, trimethylolpropane tri(meth)acrylate, tris-(2-hydroxyethyl)isocyanurate tri(meth)acrylate, pentaerythritol hexa(meth)acrylate, dipentaerythritol hexa(meth)acrylate, BPA-diepoxypropane diacrylate and ethoxylated bisphenol-A di(meth)acrylate.

For example, the (meth)acrylates mentioned are commercially available by the companies Arkema Sartomer, BASF, IMG Resins, Sigma Aldrich or TCI.

Urethane (meth)acrylates based on polyesters, polyacrylates, polyisoprenes, polyethers, polycarbonate diols and/or (hydrogenated) polybutadiene diols can be used as radically polymerizable compounds of high molecular weight.

Apart from a monofunctional (meth)acrylate, component (A) preferably comprises an at least bifunctional crosslinker based on an aliphatic and/or aromatic urethane (meth)acrylate.

Examples of suitable commercially available urethane (meth)acrylates are Visiomer HEMA-TMDI, available from the company Evonik, SUO-1020 NI (polycarbonate-based) or SUO-H8628 (polybutadiene-based), available from the company Shin-A T&C, CN9014NS, available from the company Sartomer, UV-3200B (polyester-based), available from the company Nippon Goshei, or the XMAP types (polyacrylate-based), available from the company Kaneka.

Further radically polymerizable compounds (A) that can be used in the sense of the invention are acrylic acid and methacrylic acid, acrylamides, acryloyl morpholines, bismaleimides, N-vinyl compounds, such as vinyl methyl oxazolidinone (VMOX), N-vinyl caprolactam, N-vinyl pyrrolidone and N-vinyl imidazole, as well as compounds with allyl groups such as 1,3,5-triazine-2,4,6(1H,3H,5H)-trione commercially available as TAICROS®.

Polybutadienes with free double bonds that are not hydrogenated, such as the Poly BD® types, can also be used as radically polymerizable compounds.

The above list of suitable substance classes is exemplary and is not to be construed as limiting.

In the composition according to the present invention, component (A) is preferably present in a proportion of 5 to 98 wt-%, preferably 10 to 90 wt-% or 20 to 85 wt-%, based on the total weight of components (A) to (E) of the composition, as defined below.

The weight proportion of monofunctional (meth)acrylates in component (A) is preferably 1 to 95%, more preferably 1 to 80% or 1 to 60%.

### Component (B): Radical Polymerization Initiator

Apart from component (A), the compositions according to the present invention comprise at least one radical polymerization initiator (B) based on a peroxo compound (B1), with the peroxo compound comprising at least one peroxodicarbonate.

Examples of suitable peroxodicarbonates comprise di-(4-tert-butylcyclohexyl) peroxodicarbonate, di-(2-ethylhexyl) peroxodicarbonate, di-n-butyl peroxodicarbonate, dicetyl peroxodicarbonate, dimyristil peroxodicarbonate and mixtures thereof.

Further suitable peroxo compounds (B1) are for example peroxo(di)esters, hydroperoxides, (di)alkyl peroxides, ketone peroxides, perketals, peracids and peroxomonocarbonates.

Examples of suitable peroxoesters comprise cumol peroxyneodecanoate, 1,1,3,3-tetramethylbutyl peroxyneodecanoate, tert-amyl peroxyneodecanoate, tert-butyl peroxyneodecanoate, 1,1,3,3-tetramethylbutyl peroxypivalate, tert-amyl peroxypivalate, tert-butyl peroxypivalate, didecanoyl peroxide, dilauroyl peroxide, 2,5-dimethyl-2,5-di(2-ethylhexanoylperoxy) hexane, 1,1,3,3-tetramethylbutyl-peroxy-2-ethylhexanoate, tert-amyl peroxy-2-ethylhexanoate, dibenzoyl peroxide, tert-butyl-peroxy-2-ethylhexanoate, tert-butyl peroxyisobutyrates, tert-butyl-peroxy-3,5,5-trimethyl hexanoate, tert-butyl peroxyacetate and tert-butyl peroxybenzoate.

Examples of suitable hydroperoxides comprise di-isopropylbenzene monohydroperoxide, p-menthane hydroperoxide, cumol hydroperoxide, 1,1,3,3-tetramethylbutyl hydroperoxide, tert-butyl hydroperoxide and tert-amyl hydroperoxide.

Examples of suitable alkyl peroxides (B1-c) comprise diisobutyryl peroxide, di-(3,5,5-trimetylhexanoyl) peroxide, 1,1-di-(tert-butylperoxy)-3,3,5-trimethyl cyclohexanes, 1,1-di-(tert-butylperoxy)cyclohexane, 2,2-di-(tert-butylperoxy)butane, di-tert-amyl peroxide, dicumyl peroxide, di-(2-tert-butyl-peroxyisopropyl)benzene, 2,5-dimethyl-2,5-di-(tert-butylperoxy) hexane, tert-butylcumyl peroxide, 2,5-dimethyl-2,5-di(tert-butylperoxy)hexine and di-tert-butyl peroxide.

Examples of suitable peroxomonocarbonates comprise tert-amyl-peroxy-2-ethylhexyl carbonate, tert-butyl-peroxyisopropyl carbonate and tert-butyl-peroxy-2-ethylhexyl carbonate.

In the composition according to the present invention, the peroxo compound (B1) is present in a proportion of 0.01 to 10 wt-%, preferably 0.1 to 5 wt-%, based on the total weight of the composition.

The proportion of the peroxodicarbonates in the peroxo compound (B1) is at least 10 wt-%, preferably 50 to 100 wt-%. In an advantageous embodiment, the peroxo compound (B1) is a peroxodicarbonate or a mixture of several peroxodicarbonates.

In addition, the compositions can also contain at least one radical photoinitiator (B2) which allows the compositions according to the present invention to be fixed by light.

The radical photoinitiator used in the compositions according to the present disclosure as component (B2) can preferably be activated by exposure to actinic radiation of a wavelength of 200 to 600 nm, particularly preferably of 320 to 480 nm. If required, the radical photoinitiator can be combined with a suitable sensitizer.

The common commercially available compounds such as α-hydroxy ketones, benzophenone, α,α′-diethoxy acetophenone, 2-benzyl-2-(dimethylamino)-4′-morpholinobutyrophenone, 4-isopropylphenyl-2-hydroxy-2-propyl-ketone, 4,4-bis(diethylamino)benzophenone, 2-thylhexyl-4-(dimethylamino)benzoate, ethyl-4-(dimethylamino)benzoate, 2-butoxyethyl-4-(dimethylamino)benzoate, 1-hydroxycyclohexylphenyl ketone, isoamyl-p-dimethyl aminobenzoate, methyl-4-dimethyl aminobenzoate, methyl-o-benzoyl benzoate, benzoine, benzoine ethyl ether, benzoine isopropyl ether, benzoine isobutyl ether, 2-hydroxy-2-methyl-1-phenylpropane-1-one, 2-iso-propyl thioxanthone, dibenzosuberone, ethyl-(3-benzoyl-2,4,6-trimethylbenzoyl)(phenyl)phosphinate, methyl benzoylformate, oxime ester, 2,4,6-trimethylbenzoyldiphenylphosphine oxide, ethyl-(2,4,6-trimethylbenzoyl)phenylphosphinate and bisacylphosphine oxide can be used as radical photoinitiators (B2).

Radical photoinitiators that can be activated by exposure to actinic radiation are called UV photoinitiators.

For example, the IRGACURE™ types of BASF SE, such as the IRGACURE 184, IRGACURE 500, IRGACURE 1179, IRGACURE 2959, IRGACURE 745, IRGACURE 651, IRGACURE 369, IRGACURE 907, IRGACURE 1300, IRGACURE 819, IRGACURE 819DW, IRGACURE 2022, IRGACURE 2100, IRGACURE 784, IRGACURE 250, IRGACURE TPO, IRGACURE TPO-L types, can be used as UV photoinitiators. Additionally, the DAROCUR™ types from BASF SE, for example the DAROCUR MBF, DAROCUR 1173, DAROCUR TPO and DAROCUR 4265 types, can be used.

The above list of suitable substance classes is exemplary and is not to be construed as limiting.

In the compositions according to the present disclosure, the radical photoinitiator (B2) is optionally present in a proportion of 0.01 to 7 wt-%, based on the total weight of components (A) to (E) of the composition.

### Component (C): Stabilizer

Apart from components (A) and (B), the compositions according to the present disclosure comprise at least one stabilizer (C) comprising at least one sterically hindered phenol (C1).

Particularly advantageous combinations of the reactivity of the curable compositions and the long processing time at room temperature can be achieved by using sterically hindered phenols (C1) having a molar mass of less than 500 g/mol and/or preferably having one phenol group per molecule at most.

Suitable examples of sterically hindered phenols (C1) are 2,4-di-tert-butylphenol, 2,6-di-tert-butylphenol, 2-tert-butyl-4-methylphenol, 2,6-di-tert-butyl-4-methylphenol, 2,4,6-tri-tert-butylphenol, 2,4,6-trimethylphenol, 2,6-di-tert-butyl-4-methylphenol, 2,6-di-tert-butyl-4-ethylphenol, 4,4′-methylenebis(2,6-di-tert-butylphenol), 3,5-di-tert-butyl-4-hydroxybenzyl alcohol, 3,5-di-tert-butylcatechol, 2,2-methylenebis(4-methyl-6-tert-butylphenol), 6-tert-butyl-2,4-xylenol, (ethane-1,2-diylbis(oxy))bis(ethane-2,1-diyl)bis(3-(3-(tert-butyl)-4-hydroxy-5-methylphenyl)propanoate) (Irganox245), pentaerythrityl-tetrakis(3-(3,5-bis(1,1-dimethylethyl)-4-hydroxyphenyl)propionate) (Irganox® 1010), octyl-3,5-di-tert-butyl-4-hydroxyhydrocinnamate (Irganox 1135), 3-(3,5-di-tert-butyl-4-hydroxyphenyl)-N′-[3-(3,5-di-tert-butyl-4-hydroxyphenyl)propanoyl]propanohydrazide (Irganox MD 1024), 2-methyl-4,6-bis(octylsulfanylmethyl)phenol (Irganox 1250L), 2,4-bis(dodecylthiomethyl)-6-methylphenol (Irganox 1726).

Apart from the sterically hindered phenol (C1), the compositions according to the present disclosure can comprise further suitable stabilizers, serving for example as UV and/or heat stabilizers. They are not further restricted in terms of their structure. For example, cinnamic acid esters, benzophenones, diphenylcyan acrylates, formamidines, benzylidene malonates, diaryl butadienes, triazines, HALS derivatives (hindered amine light stabilizers) and benzotriazoles can be used as UV and/or heat stabilizers.

Further examples of commercially available stabilizers are published in “Plastics Additive Handbook, 5^{th} Edition, ed., H. Zweifel, Hanser Publishers, Munich, 2001 ([1]), p. 98-136”.

In the compositions according to the present disclosure, the sterically hindered phenol (C1) is present in a proportion of 0.001 to 3 wt-%, preferably 0.01 to 1 wt-%, based on the total weight of components (A) to (E) of the composition. The other stabilizers can be present in the composition in a proportion of 0 to 5 wt-%, also based on the weight of components (A) to (E).

### Component (D): Synergist

Apart from components (A) to (C), the compositions according to the present disclosure comprise at least one synergist (D) based on a carbon allotrope having unsaturated carbon-carbon bonds.

Surprisingly, it was found that the presence of the synergist (D) in the compositions according to the present disclosure allows to achieve processing times at room temperature of at least 48 hours, preferably at least 120 hours, particularly preferably at least 168 hours.

In the compositions according to the present invention, component (D) is preferably present in a dispersed form.

The synergist (D) can be selected from the common allotropic carbon modifications, provided that the carbon allotropes have unsaturated carbon-carbon bonds.

In one embodiment of the invention, the synergist (D) can be selected from the group consisting of soot, graphite, graphene, fullerene, carbon nanotubes (CNT), carbon nanohorns (CNH) and mixtures thereof.

The use of soot, graphite and/or graphene is particularly preferred.

Examples of suitable commercially available carbon allotropes for use as a synergist (D) include Lamb Black 101 Powder, Printex 60 Powder or Special Black 100 from Orion Engineered Carbons.

Allotropes of carbon having primarily saturated carbon-carbon bonds such as diamond are unsuitable for use as a synergist in the compositions according to the present disclosure.

Unsaturated carbon compounds such as anthracene or perylene are unsuitable as a synergist (D) either.

In the compositions according to the present disclosure, the synergist (D) is present in a proportion of 0.01 to 10 wt-%, preferably 0.05 to 5 wt-%, based on the total weight of components (A) to (E) of the composition.

### Component (E): Additives

Additionally, the compositions described can contain facultative constituents as further additives (E). The additives (E) are preferably selected from the groups of fillers, colorants, pigments, anti-ageing agents, fluorescents, polymerization accelerants, sensitizers, adhesion promoters, desiccants, crosslinkers, flow improvers, wetting agents, thixotropic agents, diluents, flexibilizers, polymeric thickeners, flame retardants, corrosion inhibitors, plasticizers and tackifiers as well as combinations thereof.

In the compositions according to the present disclosure, the additives (E) can be contained in a proportion of 0 to 85 wt-%, preferably 1 to 65 wt-%, based on the total weight of the composition.

In the sense of the present disclosure, the synergists (D) are not considered as additives, in particular not as fillers, colorants or pigments.

### Additional Reactive Resin Compositions

The thermosetting composition according to the present disclosure that is formed by the above-described components (A) to (E) can be used alone or together with additional reactive resin compositions. The additional reactive resin compositions are not further restricted in terms of their chemical structure and composition. In particular, the additional reactive resin compositions can comprise additional reactive resins (F), curing agents (G) and/or initiators (H) for the polymerization or crosslinking of the additional reactive resins (F) as reactive components.

Then, the additional reactive resin compositions present in a mixture with the thermosetting composition according to the present disclosure made of components (A) to (E) can be fixed in a dimensionally stable state by heating and activating the thermosetting composition according to the present invention at a low temperature and passed to further processing steps.

Below, the components of the additional reactive resin compositions will be described in detail.

### Component (F): Additional Reactive Resins

For example, at least one cationically polymerizable or addition-crosslinking compound selected from the group of epoxy-containing compositions (F1), oxetanes (F2) and vinyl ethers (F3) as well as combinations thereof can be used as component (F).

### Epoxy-Containing Compound (F1):

In the additional reactive resin compositions, at least one epoxy-containing compound (F1) can be used as an additional reactive resin, which can be mono- or bifunctional or of a higher functionality.

For example, the epoxy-containing compound (F1) can comprise cycloaliphatic epoxides, aromatic and aliphatic glycidyl ethers, glycidyl esters or glycidyl amines as well as mixtures thereof.

Preferably, the additional reactive resin comprises one or several at least bifunctional epoxy-containing compounds. Here, “at least bifunctional” means that the epoxy-containing compound contains at least two epoxy groups.

In addition to the at least bifunctional epoxy-containing compounds, monofunctional epoxides can also be used as reactive diluents.

A combination of several epoxy-containing compounds at least one of which is bifunctional or of a higher functionality is also in the sense of the invention.

Bifunctional cycloaliphatic epoxy resins are known in the state of the art and contain compounds carrying both a cycloaliphatic group and at least two oxirane rings. Exemplary representatives are 3-cyclohexenylmethyl-3-cyclohexylcarboxylate diepoxide, 3,4-epoxycyclohexylalkyl-3′,4′-epoxycyclohexane carboxylate, 3,4-epoxy-6-methylcyclohexyl-methyl-3′,4′-epoxy-6-methylcyclohexane carboxylate, vinylcyclohexene dioxide, bis(3,4-epoxycyclohexylmethyl)adipate, dicyclopentadiene dioxide and 1,2-epoxy-6-(2,3-epoxypropoxy)hexahydro-4,7-methane indane as well as mixtures thereof.

Aromatic epoxy resins can also be used in the additional reactive resin compositions. Examples of aromatic epoxy resins are bisphenol-A epoxy resins, bisphenol-F epoxy resins, phenol-novolac epoxy resins, cresol-novolac epoxy resins, biphenyl epoxy resins, 4,4′-biphenyl epoxy resins, divinylbenzene dioxide, 2-glycidylphenyl glycidyl ethers, naphthalenediol diglycidyl ethers, glycidyl ethers of tris(hydroxyphenyl)methane and glycidyl ethers of tris(hydroxyphenyl)ethane as well as mixtures thereof. Furthermore, all completely or partially hydrogenated analogues of aromatic epoxy resins can be used as well.

Isocyanurates substituted with epoxy-containing groups and other heterocyclic compounds can also be used in the additional reactive resin compositions. Triglycidyl isocyanurate and monoallyl diglycidyl isocyanurate can be given as examples.

In addition, polyfunctional epoxy resins of all resin groups, viscoplastic epoxy resins and mixtures of various epoxy resins can be used in the additional reactive resin compositions.

Examples of commercially available epoxy-containing compounds are products available under the tradenames CELLOXIDE™ 2021P, CELLOXIDE™ 8000 from Daicel Corporation, Japan, EPIKOTE™ RESIN 828 LVEL, EPIKOTE™ RESIN 166, EPIKOTE™ RESIN 169 from Momentive Specialty Chemicals B. V., Netherlands, Epilox™ resins of the product series A, T and AF from Leuna Harze, Germany, or EPICLON™ 840, 840-S, 850, 850-S, EXA850CRP, 850-LC from DIC K. K., Japan, Omnilane 1005 and Omnilane 2005 from IGM Resins B. V., Syna Epoxy 21 and Syna Epoxy 06 from Synasia Inc., TTA21, TTA26, TTA60 and TTA128 from Jiangsu Tetra New Material Technology Co. Ltd.

### Oxetanes (F2)

Instead of or in addition to the epoxy-containing compound (F1), preferably oxetane-containing compounds (F2) can be used in the additional reactive resin compositions as cationically or addition-curable components (F). Methods for producing oxetanes are known, in particular from US 2017/0198093 A1.

Examples of commercially available oxetanes are bis(1-ethyl-3-oxetanylmethyl) ethers (DOX), 3-allyloxymethyl-3-ethyl oxetanes (AQX), 3-ethyl-3-[(phenoxy)methyl oxetanes (POX), 3-ethyl-3-hydroxymethyl oxetanes (OXA), 1,4-bis[(3-ethyl-3-oxetanylmethoxy)methyl]benzene (XDO), 3-ethyl-3-[(2-ethylhexyloxy)methyl]oxetane (EHOX). The oxetanes named are commercially available from the company TOAGOSEI CO., LTD. Oxetanes of a higher functionality are also in the sense of the invention.

### Vinyl Ethers (F3):

Instead of or in addition to components (F1) and (F2), vinyl ethers (F3) can be used as cationically or addition-curable compounds in the additional reactive resin compositions.

Preferably, the additional reactive resins comprise one or several at least bifunctional vinyl ethers. Here, “at least bifunctional” means that the vinyl ether contains at least two vinyl groups.

Suitable vinyl ethers are trimethylolpropane trivinyl ether, ethylene glycol divinyl ether, triethylene glycol divinyl ether (DVE-3), 1,4-butanediol divinyl ether (BDDVE), 1,4-cyclohexanedimethanol divinyl ether (CHDM-di), 1,2,3-tris(vinyloxy)propane, 1,3,5-tris[(2-vinyloxy)ethoxy]benzene, tris[4-(vinyloxy)butyl]-1,2,4-benzene tricarboxylates, 1,3,5-tris(2-vinyloxyethyl)-1,3,5-triazine, 1,3,5-cyclohexanetrimethanol trivinyl ether, 1,1,1-tris-4-[2-(vinyloxy)ethoxy]phenylethane, tetrakis(vinyloxymethyl)methane and cyclic vinyl ethers as well as their mixtures. In addition, vinyl ethers of polyfunctional alcohols can be used.

### Hybrid Compounds (F4):

In one embodiment, the additional reactive resins can comprise at least one hybrid compound (F4). The hybrid compound is characterized by having at least one (meth)acrylate group and at least one cationically polymerizable or addition-crosslinking group of components (F1) to (F3). Thus, the hybrid compound is a compound of mixed functionality.

Hybrid compounds (F4) which, apart from the vinyl or epoxy groups mentioned, carry additional (meth)acrylate functions are preferred; epoxy acrylate hybrid monomers are particularly preferred.

Examples of commercially available epoxy (meth)acrylates are CYCLOMER M100 from the company Daicel, Epoxy Acrylat Solmer SE 1605, UVACURE 1561 from the company UCB, Miramer PE210HA from the company Miwon Europe GmbH and Solmer PSE 1924 from the company Soltech Ltd. Also oxetane (meth)acrylates such as Eternacoll OXMA from the company UBE Industries LTD.

In the additional reactive resin compositions, the additional reactive resins (F1) to (F4) can be contained in proportions of 20 to 99.99 wt-%, preferably 30 to 70 wt-% or 92 to 99.99 wt-%, based on the weight of components (F) to (H).

### Curing Agent (G):

In addition, the additional reactive resin compositions can contain a curing agent (G) for the crosslinking of component (F), for example by addition polymerization. The curing agents are not further restricted in terms of their chemical nature.

For example, nitrogen-containing compounds (G1) can be used as curing agents (G) for the curing of addition-crosslinking components (F), in particular of epoxy-containing components (F1). Other possible curing agents are thiols and/or anhydrides.

Examples of suitable nitrogen-containing compounds comprise amines, in particular aliphatic polyamines, arylaliphatic polyamines, cycloaliphatic polyamines, aromatic polyamines and heterocyclic polyamines, as well as imidazoles, cyanamides, polyureas, Mannich bases, polyether polyamines, polyaminoamides, phenalkamines, sulfonamides, aminocarboxylic acids or combinations of the substance classes named.

Reaction products of epoxides and/or anhydrides and the above-mentioned nitrogen-containing compounds can also be used as curing agents (G).

In the additional reactive resin compositions, the curing agent (G) can be contained in proportions of 20 to 80 wt-%, preferably 30 to 70 wt-%, based on the weight of components (F) to (H).

Preferably, the addition-crosslinking reactive resin compositions do not contain a cationic polymerization initiator (H).

### Additional Initiator (H):

The additional reactive resin compositions can be formulated as cationically polymerizable compositions. In this case, the additional reactive resin compositions can contain, apart from component (F), an additional initiator (H) for the cationic polymerization of the additional reactive resins (F). Preferably, the additional initiator is a photolatent acid (H1) that can be activated by exposure to actinic radiation, and comprises for example initiators based on metallocenium and/or onium compounds.

An overview of various metallocenium salts is disclosed in EP 0 542 716 B1. HSO₄⁻, PF₆⁻, SbF₆⁻, AsF₆⁻, Cl⁻, Br⁻, I⁻, ClO₄⁻, PO₄⁻, SO₃CF₃⁻, OTs⁻ (tosylate), aluminate and borate anions such as BF₄⁻ and B(C₆F₅)₄⁻ can be named as examples of various anions of metallocenium salts.

Preferably, the photolatent acid based on a metallocenium compound is selected from the group of ferrocenium salts.

Preferred onium compounds are selected from the group of arylsulfonium salts und aryliodonium salts and combinations thereof, and are described in the state of the art.

Triarylsulfonium-based photoinitiators commercially available as photolatent acids are available under the tradenames Chivacure 1176, Chivacure 1190 from the company Chitech, Irgacure 290, Irgacure 270, Irgacure GSID 26-1 from the company BASF, Speedcure 976 and Speedcure 992 from Lambson, TTA UV-692, TTA UV-694 from the company Jiangsu Tetra New Material Technology Co., Ltd. or UVI-6976 and UVI-6974 from the company Dow Chemical Co.

Diaryliodonium-based photoinitiators commercially available as photolatent acids are for example available under the tradenames UV1242 or UV2257 from the company Deuteron and Bluesil 2074 from the company Bluestar.

The photolatent acids (H1) used in the additional reactive resin compositions are preferably activatable by irradiation with actinic radiation of a wavelength of 200 to 480 nm.

Instead of or in addition to the photolatent acids (H1), the additional reactive resin compositions can also contain a thermally latent acid (H2) as an additional initiator for cationic polymerization. For example, quaternary N-benzylpyridinium salts and N-benzylammonium salts as disclosed in EP 0 343 690 or WO 2005/097883 are suitable as a thermally latent acid. Besides, thermally latent sulfonium salts as described in WO 2019/043778 A1 can be used as acid generators.

Commercially available products are available under the designations K-PURE CXC-1614 or K-PURE CXC-1733 from King Industries Inc.; SAN-AID SI-80L and SAN-AID SI-100L from the company SAN-SHIN Chemical Industry Co. Ltd.

Moreover, various metal chelate complexes based on titanium or aluminum can be used as a thermally latent acid.

In the additional reactive resin compositions, the additional initiator (H) can be contained in proportions of 0.01 to 10 wt-%, preferably 0.01 to 5 wt-% and particularly preferably 0.1 to 3 wt-%, based on the weight of components (F) to (H). Preferably, the cationically polymerizable reactive resin compositions do not contain a curing agent (G).

### Formulation of the Compositions

A formulation of the thermosetting compositions according to the present invention comprises at least components (A) to (D). In addition, additives (E) can be optionally contained.

In one embodiment, the composition according to the present disclosure consists of components (A) to (D) and optionally (E).

In another embodiment, the composition according to the present disclosure can be present in a mixture with an additional reactive resin composition made of components (F) to (H).

In a first preferred embodiment, the thermosetting composition according to the present disclosure comprises or consists of the following components, each based on the total weight of components (A) to (E):
(A) 10 to 90 wt-% of a (meth)acrylate, in particular 5 to 60 wt-% of a monofunctional (meth)acrylate, and/or 1 to 50 wt-%, preferably 1 to 40 wt-% of an at least bifunctional (meth)acrylate or a (meth)acrylate of a higher functionality as a crosslinker;
(B) 0.2 to 5 wt-% of a peroxodicarbonate;
(C) 0.01 to 1 wt-% of at least one stabilizer selected from the group of sterically hindered phenols;
(D) 0.01 to 5 wt-% of a synergist based on a carbon allotrope having unsaturated carbon-carbon bonds, with the carbon allotrope preferably comprising soot;
(E) 0 to 85 wt-% of further additives, preferably 5 to 65 wt-%.

In a second preferred embodiment, the composition according to the present disclosure is preferably in a mixture with an additional reactive resin composition. In particular, the composition according to the present invention can have the composition described above for the first embodiment.

In particular, the additional reactive resin composition of the second embodiment is a cationically polymerizable reactive resin composition and comprises or consists of the following components:
(F) 92 to 99.99 wt-% of additional resin constituents (F), comprising at least one bifunctional epoxy-containing compound (F1) selected from the group of cycloaliphatic epoxides, aliphatic and/or aromatic glycidyl ethers;
(H) 0.01 to 8 wt-% of a cationic polymerization initiator selected from the group of photolatent or thermally latent acidifiers,
with the proportions of (F) and (H) in the additional reactive resin composition adding up to 100 percent.

A preferred formulation of the second embodiment comprises a thermosetting composition made of the following components:
(A) 10 to 90 wt-% of a (meth)acrylate, in particular 5 to 60 wt-% of a monofunctional (meth)acrylate, and/or 1 to 30 wt-% of an at least bifunctional (meth)acrylate or a (meth)acrylate of a higher functionality as a crosslinker;
(B) 0.2 to 5 wt-% of a peroxodicarbonate;
(C) 0.01 to 1 wt-% of at least one stabilizer selected from the group of sterically hindered phenols;
(D) 0.01 to 5 wt-% of a synergist based on a carbon allotrope having unsaturated carbon-carbon bonds, with the carbon allotrope preferably comprising soot;
(E) 5 to 85 wt-% of further additives;
with the proportions of components (A) to (E) of the thermosetting composition adding up to 100 percent; and
a cationically polymerizable reactive resin composition with the following components:
(F) 92 to 99.9 wt-% of an additional reactive resin (F), comprising at least one bifunctional epoxy-containing compound (F1) selected from the group of cycloaliphatic epoxides, aliphatic and/or aromatic glycidyl ethers; and
(H) 0.01 to 5 wt-% of a cationic polymerization initiator selected from the group of photolatent or thermally latent acidifiers,
with the proportions of components (F) and (H) in the cationically polymerizable reactive resin composition adding up to 100 percent; and
with the proportion of the thermosetting composition with components (A) to (E) in the formulation being 10 to 90 wt-% and the proportion of the cationically polymerizable reactive resin composition made of components (F) and (H) being 10 to 90 wt-%.

The compositions according to the present disclosure can be provided both in a single-component and a multi-component form.

In a third embodiment, the thermosetting composition according to the present disclosure is provided as a multi-component composition and comprises the following components, which are distributed to two packaging units PU1 and PU2, with the weight indications based on the total weight of each packaging unit PU1 and PU2:
Packaging unit PU1:
(A) 10 to 80 wt-% of a monofunctional (meth)acrylate and/or 10 to 50 wt-% of an at least bifunctional (meth)acrylate or a (meth)acrylate of a higher functionality as a crosslinker;
(C) 0.01 to 0.1 wt-% of at least one stabilizer selected from the group of sterically hindered phenols;
(D) 0.01 to 1 wt-% of a synergist based on a carbon allotrope having unsaturated carbon-carbon bonds, preferably soot;
(E) 0 to 40 wt-% of additives.
Packaging unit PU2:
(B) 1 to 50 wt-% of a peroxodicarbonate; and
(E) 50 to 99 wt-% of additives.

Usually, the packaging units PU1 and PU2 are mixed at a ratio of 10:1 to 1:1 (PU1:PU2) so that the proportion of the peroxodicarbonate is in the range of approx. 0.2 to 5 wt-%, based on the total weight of the readily mixed composition.

### Properties of the Compositions:

The thermosetting compositions according to the present invention are characterized by a high reactivity and, at the same time, a long processing time at room temperature.

The compositions can be cured at a temperature of less than 100° C., preferably less than 90° C., more preferably less than 80° C., within a short time. Typically, the compositions are completely cured at a temperature of 100° C. within less than 5 min, at 90° C. within less than 15 min and at 80° C. within less than 30 min. Curing at 60° C. is also possible.

At the same time, the compositions have a processing time at room temperature of at least 72 h, preferably at least 120 h, particularly preferably at least 168 h.

At temperatures of −18° C., the compositions can be stored for at least 3 months without any reduction of the processing time at room temperature.

Apart from the reactivity and the long processing time the cured compositions are characterized by high adhesion on plastics which are otherwise difficult to join. This comprises in particular the plastics polyethylene (PE), polypropylene (PP), polycarbonate (PC), acrylonitrile-butadiene-styrene copolymer (ABS), polystyrene (PS), liquid crystal polymer (LCP) and cyclic olefin polymer (COP) as well as the plastics mixture of polycarbonate/acrylonitrile-butadiene-styrene (PC/ABS). In particular, strengths of more than 8 MPa, preferably more than 10 MPa, particularly preferably more than 15 MPa, are achieved when bonding substrates based on polycarbonate.

Strength, in particular compression shear strength, and adhesion properties of the cured compositions can be set over a wide range, in particular by varying component (A).

Use of the thermosetting compositions Due to their low curing temperature the compositions according to the present disclosure are specifically suitable for temperature-sensitive joining or encapsulating processes. Thus, in particular optical or electronical substrates tolerating only a limited heat input can be reliably joined, coated, encapsulated or bonded by using the compositions according to the present invention. Despite the low curing temperature high strengths even on substrates with a low surface energy are achieved so that parts with a high life-time reliability can be produced.

Due to the long processing times at room temperature the compositions can also be easily used in complex industrial processes, even after prolonged downtimes, without having to be removed from the plant and transferred to a cold storage cell during elongated dosage breaks.

In particular, the compositions according to the present disclosure are suitable for use in optoelectronics. A possible use is the bonding of optical devices such as lenses.

Methods using the compositions according to the present invention According to the present disclosure, the thermosetting composition is used for the joining, encapsulating or coating of substrates, with the method comprising the following steps:
a) providing the composition according to the present disclosure;
b) dosing the composition onto a first substrate;
c) optionally feeding a second substrate to the composition;
d) optionally fixing the composition by exposure to actinic radiation; and
e) heating the composition and the substrate and/or the substrate composite to a temperature of 60 to 100° C. for 5 to 60 minutes while curing the composition.

### Measuring Methods Used and Definitions

### Irradiation

For irradiation, the compositions according to the present disclosure were irradiated by LED lamps of the DELOLUX series from the company DELO Industrie Klebstoffe GmbH & Co. KGaA with a wavelength of 400 nm at an intensity of 200±20 mW/cm².

### Room Temperature

Room temperature is defined as 23±2° C.

### Determination of Viscosity

Viscosity was determined at 23° C. and at a shear rate of 10/second using a Physica MCR302 rheometer from the company Anton Paar having a standardized PP20 measuring cone with a 200 μm slot.

### Processing Time

To determine the processing time, the viscosity was checked within the first 24 h after the production by mixing all components of the respective composition at room temperature at intervals of 6 h. Then, the viscosity was checked every 24 h. When the viscosity increased by more than 30% relative to the viscosity initially measured directly after the production or the curing of the composition in the container, the time previously established as suitable was determined as the maximum processing time.

### Compression Shear Strength

Two specimens (dimensions 20 mm*20 mm*5 mm) made of polycarbonate were bonded by using the respective composition, with an overlap of 5 mm. To this end, a bead of the composition was applied to the first specimen and spread in a thin layer. Then, a second specimen was joined. The thickness of the adhesive layer of 0.1 mm and the overlap were set by a bonding device. The joined specimens were cured for 30 min at 80° C. Prior to curing, the minimum adhesive throat seam of the specimens can be fixed by light curing, with the light curing performed under conditions guaranteeing that the adhesive in the actual bonding area remains completely uncured. Strengths of less than 6 MPa are insufficient, strengths of 6 to 8 MPa are poor, strengths of 8 to 10 MPa are sufficient, strengths of 10 MPa to 20 MPa are good and strengths of more than 20 MPa are very good.

### DSC Measurements

DSC measurements of the reactivity were performed using a differential scanning calorimeter (DSC) of the DSC 822e or DSC 823e type from the company Mettler Toledo.

To this end, 6 to 10 mg of the liquid sample is weighted into an aluminum crucible (40 μL) with a pin, sealed with a perforated lid and subjected to a measurement over a range of 40 to 130° C. at a heating rate of 1 K/min. The process gas is nitrogen (volume flow 50 mL/min).

The peak temperature is evaluated.

### Production of the Curable Compositions

First, the liquid constituents are mixed and then the fillers and optionally further solids are incorporated by using a laboratory agitator, laboratory dissolver or speed mixer (Fa. Hauschild) until a homogeneous composition is formed. Accordingly, compositions that contain the photoinitiators and are sensitive to visible light have to be produced by using light of an excitement wavelength other than those used for the photoinitiators or sensitizers. The peroxo compound (B) is added at the end of the production, and the composition is mixed at a controlled temperature. Preferably, the temperature does not exceed 30° C.

The thus produced compositions were filled in single-chamber cartridges or multi-chamber cartridges and sealed.

### Exemplary Embodiments and Comparative Examples

Below, the compositions according to the present disclosure were produced and the properties of the compositions were compared to those of selected comparative examples und of compositions from the state of the art. The results are stated in Tables 1 to 3. In the Tables, the amounts are given in wt-%.

In the following list, all compounds used to produce the compositions as well as their abbreviations are stated:

### Component (A): Radically Curable Compound

(A1) isorbornyl acrylate (IBOA), available from the company Sigma Aldrich
(A2) isorbornyl methacrylate (IBOMA), available from the company Sigma Aldrich
(A3) acrylic acid, available from the company Sigma Aldrich
(A4) N,N-dimethyl acrylamide, available from the company Sigma Aldrich
(A5) UV 3200B, urethane acrylate, available from the company Mitsubishi Chemical Corporation
(A6) Miramer M1530, propoxylated THF acrylate, available from the company Miwon
(A7) PEAM-645, polyester acrylate, available from the company Designer Molecules
(A8) SR833S, bifunctional cycloaliphatic acrylate, available from the company Sartomer

### Component (B): Radical Polymerization Initiator

(B1-1) tert-butylperoxy neodecanoate, available from the company Pergan (tradename Peroxan PND)
(B1-2) di(2-ethylhexyl) peroxodicarbonate, available from the company United Initiators (tradename: EHPC-75-AL)
(B1-3) di(4-tert-butylcyclohexyl) peroxodicarbonate, available from the company United Initiators (tradename: BHPC)
(B2-1) 2,4,6-trimethylbenzoyldiphenylphosphine oxid, available from the company BASF (tradename: TPO-L)
(B2-2) diphenyl-(2,4,6-trimethylbenzoyl)phosphine oxide, available from the company BASF (tradename: TPO)
(B2-3) 2-hydroxy-2-methyl propiophenone, available from the company IGM Resins (tradename: Omnirad 73)

### Component (C): Stabilizer

(C1) 2,6-di-tert-butyl-4-methylphenol (BHT), available from the company Sigma Aldrich
(C2) 4-methoxyphenol (HQMME), available from the company Sigma Aldrich
(C3) phenothiazine, available from the company Sigma Aldrich
(C4) 2,2,6,6-tetramethylpiperidinyloxyl (TEMPO), available from the company Sigma Aldrich

### Component (D): Synergist

(D1) Special Black 100, available from the company Continental Carbon Company

### Component (E): Additives

(E1) HDK H2000, fumed silica, available from the company Wacker
(E2) Aerosil R 208, fumed silica coated with polydimethyl siloxane, available from the company Evonik
(E3) (3-glycidyloxypropyl)trimethoxysilane, available from the company Evonik (tradename Dynasilan Glymo)
(E4) SFP-30M, fumed silica, available from the company Denka
(E5) San-Aid SI-S stabilizer, available from the company Sanshin Chemical Industry Co. Ltd

### Component (F): Additional Reactive Resins: Epoxy-Containing Compound (F1) and Oxetanes

(F2):
(F1-1) Epikote Resin 169, bisphenol-A/F glycidyl ether, available from the company Hexion
(F1-2) Celloxide 2021P, cycloaliphatic epoxide, available from the company Daicel
(F1-3) jER YL 980, bisphenol-A glycidyl ether, available from the company Mitsubishi Chemicals
(F2-1) bis[1-ethyl(3-oxetanyl)]methyl ether, available from the company Toagosei (tradename: OXT 221)

### Curing Agent (G)

(G1-1) Adeka EH-5057PK, polyamine, available from the company Adeka

### Cationic Polymerization Initiator (H)

(H2-1) K-Pure CXC-1821, thermal acid generator, available from the company King Industries

TABLE 1

| | | | | | | | | | | | Examples according to the | | | | | | |
|---|---|---|---|---|---|---|---|---|---|---|---|---|---|---|---|---|---|
| Components | | Comparative examples | | | | | | | | | present invention | | | | | | |
| Example | | R1 | R2 | R3 | R4 | R5 | R6 | R7 | R8 | R9 | E1 | E2 | E3 | E4 | E5 | E6 | E7 |
| A1 | IBOA | 28 | 28 | 28 | 28 | 28 | 28 | 28 | 28 | 28 | 28 | | 28 | 28 | 28 | 28 | 28.8 |
| A2 | IBOMA | | | | | | | | | | | 28 | | | | | |
| A3 | Acrylic acid | 4 | 4 | 4 | 4 | 4 | 4 | 4 | 4 | 4 | 4 | 4 | 4 | 4 | 4 | 4 | 4 |
| A4 | Dimethyl | 9 | 9 | 9 | 9 | 9 | 9 | 9 | 9 | 9 | 9 | 9 | 9 | 9 | 9 | 9 | 9 |
| | acrylamide | | | | | | | | | | | | | | | | |
| A5 | UV 3200 B | 45.2 | 45.1 | 45 | 45.1 | 45 | 45 | 45 | 46.5 | 46.4 | 45 | 45 | 45.05 | 44.9 | 45.09 | 44.8 | 45 |
| B1-1 | TBPND | | | | | | | | 1.6 | 1.6 | | | | | | | |
| B1-2 | EHPC-75 AL | 3 | 3 | 3 | 3 | 3 | 3 | 3 | | | 3 | 3 | 3 | 3 | 3 | 3 | 3 |
| B2-1 | TPO-L | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | |
| C1 | BHT | | 0.1 | 0.2 | | | | | 0.1 | 0.1 | 0.1 | 0.1 | 0.05 | 0.2 | 0.1 | 0.1 | |
| C2 | HQMME | | | | | 0.1 | | | | | | | | | | | |
| C2 | Phenothiazine | | | | | | 0.1 | | | | | | | | | | |
| C3 | TEMPO | | | | | | | 0.1 | | | | | | | | | |
| D1 | Special | | | | 0.1 | 0.1 | 0.1 | 0.1 | | 0.1 | 0.1 | 0.1 | 0.1 | 0.1 | 0.01 | 0.3 | 0.1 |
| | Black 100 | | | | | | | | | | | | | | | | |
| E1 | HDK H 2000 | 10 | 10 | 10 | 10 | 10 | 10 | 10 | 10 | 10 | 10 | 10 | 10 | 10 | 10 | 10 | 10 |

| | | | | | | | | | | | | | | | | |
|---|---|---|---|---|---|---|---|---|---|---|---|---|---|---|---|---|
| DSC peak temperature [° C.] | 48 | 49 | 52 | 52 | 62 | n.d. | 57 | 54 | 54 | 72 | 72 | 66 | 77 | 65 | 72 | 72 |
| Processing time at RT [h] | <6 | 24 | 48 | 48 | <6 | <1 | <24 | 72 | 72 | 168 | 168 | 72 | 336 | 168 | 168 | 168 |
| Compression shear strength | 25 | 13 | 10 | 10 | 20 | n.d. | 15 | <1 | <1 | 40 | 30 | 45 | 35 | 30 | 50 | 37 |
| [PC-PC] after curing at | | | | | | | | | | | | | | | | |
| 80° C. for 30 min [MPa] | | | | | | | | | | | | | | | | |

TABLE 2

| | | | | Examples |
|---|---|---|---|---|
| | | Comparative | | according to the |
| Components | | examples | | present invention |
| Example | | R10 | R11 | E8 |
| A6 | Miramer M1530 | 10.23 | | |
| A7 | PEAM-645 | 40.89 | 25.68 | 25.58 |
| A1 | IBOA | | 14.13 | 14.13 |
| A8 | SR833S | | 12.84 | 12.84 |
| B1-3 | BCHPC | 3.01 | 4.75 | 4.75 |
| B2-2 | TPO | 2 | 0.5 | 0.5 |
| B2-3 | Omnirad 73 | | 2 | 2 |
| C1 | BHT | | | 0.1 |
| C2 | HQMME | 0.02 | | |
| D1 | Special Black 100 | 0.25 | 0.15 | 0.15 |
| E2 | Aerosil R 208 | 2 | 2.88 | 2.88 |
| E3 | Glymo | 1 | | |
| E4 | Denka SFP-30M | 40.6 | 37.07 | 37.07 |

| | | | |
|---|---|---|---|
| DSC peak temperature [° C.] | 56 | 51 | 70 |
| Processing time at RT [h] | 24 | <24 | 168 |
| Compression shear strength | 35 | 45 | 42 |
| [PC-PC] after curing at 80° C. | | | |
| for 30 min [MPa] | | | |

TABLE 3

| | | Examples according to |
|---|---|---|
| Components | | the present invention |
| Example | | E9 |
| A1 | IBOA | |
| A8 | SR833S | 26 |
| A5 | UV 3200B | 22 |
| B1-2 | EHPC-75 AL | 1.9 |
| B2-1 | TPO-L | 0.8 |
| C1 | BHT | 0.1 |
| D | Special Black 100 | 0.1 |
| E1 | HDK H2000 | 7 |
| E5 | San-Aid SI-S | 0.1 |
| F1-2 | Celloxide 2021P | 20 |
| F2-1 | Oxetane OXT 221 | 20 |
| H2-1 | K-Pure CXC-1821 | 1 |

| | |
|---|---|
| DSC peak temperature [° C.] | 75 |
| Processing time at RT [h] | >168 |
| Compression shear strength [PC-PC] | 18 |
| after curing at 80° C. for 30 min [MPa] | |

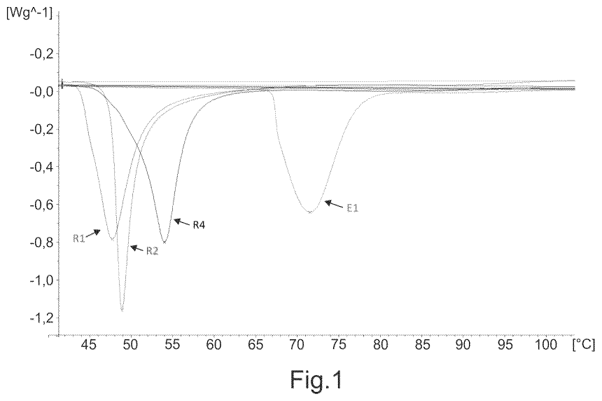

Table 1 juxtaposes the examples according to the present invention E1 to E7 and the comparative examples R1 to R9. The examples according to the present invention E1 and E7 show that by the advantageous combination of components (A) to (D) in a curable composition based on acrylates a long processing time at room temperature of at least 168 hours and, at the same time, a low curing temperature, characterized by a DSC peak temperature of 72° C., can be achieved (FIG. 1). Furthermore, the compositions according to the present invention E1 and E7 offer a high strength on polycarbonate of 37 and 40 MPa, respectively, in the cured state. Example E2 shows that, in analogy, a similar behavior can be achieved with methacrylate-containing systems.

The DSC peak temperature can be further lowered by a reduced stabilization due to the addition of 0.05 wt-% of the stabilizer C1 (example E3) without the processing time falling below 3 days at room temperature. At the same time, a remarkable strength when bonding polycarbonate continues to be achieved.

Higher proportions of the stabilizer C1 (0.2 wt-%) increase the processing time to up to 2 weeks, as shown in example E4. Nonetheless, a high reactivity (DSC peak temperature 77° C.) is maintained. The compositions according to the present invention are processable even after a 2-week storage at room temperature and are unlimitedly curable below 80° C.

However, as soon the addition of the stabilizer is dispensed with (comparative example R4) or only stabilizers not selected from the group of sterically hindered phenols are used (see R5, R6 and R7), the processing times at room temperature fall below 24 h. For example, comparative example R6 shows only an unacceptable processing time of less than one hour when not using the sterically hindered phenol as a stabilizer (C)

Surprisingly, not using the synergist (D1) also results in a low processing time of a maximum of 24 h, as shown in comparative example R2. Without component (D1), the respective formulations are unstable at room temperature (DSC peak temperature 49° C.). Comparative example R3 shows that the reduced stability at room temperature cannot be compensated by higher amounts of the stabilizer. At the same time, when component D1 is dispensed with only mediocre strengths are achieved when bonding plastics, both in example R2 and R3.

However, if components (A) to (D) are combined in the sense of the invention, even 0.01 wt-% of the synergist D is sufficient to achieve the three advantageous properties stability, reactivity and adhesion (example E5).

If, in addition to the synergist D1, the stabilizer C1 is dispensed with as well (comparative example R1), the processing times are so low that the formulations cannot be reasonably handled at room temperature.

FIG. 1 shows DSC curves of comparative examples R1, R2 and R4 and of the example according to the present invention E1. The compositions of the comparative examples R1, R2 and R4 formulated without the synergist and/or the stabilizer have a DSC peak temperature near room temperature. Thus, these compositions show an insufficient processing time at room temperature and can therefore not be stably formulated. In contrast, the composition according to the present invention E1 shows a balanced profile of the properties reactivity and stability. Composition E1 continues to be processible at room temperature while being curable at a low temperature.

As a component allowing curing at low temperatures, the compositions comprise at least one peroxodicarbonate as a radical polymerization initiator. If the peroxodicarbonate is dispensed with and only an alternative peroxide is used as an initiator (comparative examples R8 and R9), low-stability formulations are obtained, showing unacceptably poor adhesion values, in particular on polycarbonate, in the cured state. Even the addition of the synergist D1 in combination with another peroxide does not result in an improvement of the stability and/or adhesion (comparative example R9).

Table 2 contains formulation E3 from WO 2018/089494 A1 as a comparative example. Although in comparative example R11 0.15 wt-% of the synergist D1 is used, no sterically hindered phenol is used as stabilizer C1. The cured composition from WO 2018/089494 A1 achieves a high strength on polycarbonate, but this is to the disadvantage of a short processing time at room temperature of less than 24 h. In contrast, the example according to the present invention E8 additionally contains the stabilizer C1 and thus achieves a processing time of 7 days at a DSC peak temperature of 70° C. By adding a radical photoinitiator the composition from example E8 can be additionally fixed by exposure to light.

If, according to comparative example R10 that corresponds to example E6 from WO 2018/089494 A1, only the proposed stabilizer C2 is used without the addition of a sterically hindered phenol, the processing time at room temperature does not improve substantially and is with 24 h far below the advantageous 72 h of the compositions according to the present intention.

Table 3 illustrates the second embodiment of the invention. Example E9 shows that the thermosetting composition with components (A) to (E) can be used just as advantageously in a formulation with a cationically polymerizable reactive resin composition additionally containing, apart from the epoxides F1-2 and F1-3, a thermally latent initiator (H2-1) for cationic polymerization.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A thermosetting composition, comprising:
(A) at least one radically curable compound, wherein the radically curable compound comprises at least one (meth)acrylate,
(B) at least one radical initiator based on a peroxo compound, wherein the peroxo compound comprises at least one peroxodicarbonate,
(C) at least one stabilizer comprising at least one sterically hindered phenol, and
(D) at least one synergist based on a carbon allotrope having unsaturated carbon-carbon bonds.

2. The composition according to claim 1, wherein the at least one (meth)acrylate is selected from the group consisting of aliphatic, optionally linear or branched, cycloaliphatic, aromatic and heterocyclic (meth)acrylates, with the (meth)acrylate preferably comprising a monofunctional (meth)acrylate together with an at least bifunctional (meth)acrylate as a crosslinker.

3. The composition according to claim 1, wherein the sterically hindered phenol has a molar mass of less than 500 g/mol and/or a single phenol group per molecule.

4. The composition according to claim 1, wherein component (D) is selected from the group consisting of soot, activated carbon, graphene, graphite, fullerene, carbon nanotubes, carbon nanohorns and combinations thereof.

5. The composition according to claim 1, wherein the thermosetting composition comprises at least one further additive, preferably at least one further additive from the group of toughness modifiers, colorants, pigments, fluorescents, thixotropic agents, thickeners, stabilizers, antioxidants, plasticizers, tackifiers, catalysts, fillers, flame retardants, desiccants, corrosion inhibitors, inert and reactive diluents, levelling and wetting agents or adhesion promoters.

6. The composition according to claim 1, wherein the thermosetting composition comprises the following components:
(A) 5-98 wt-%, preferably 10 to 90 wt-% or 0-85 wt-% of the radically curable compound, with the radically curable compound comprising at least one (meth)acrylate;
(B) 0.01-10 wt-%, preferably 0.1-5 wt-% of the radical initiator, with the radical initiator comprising at least one peroxodicarbonate, and optionally a radical photoinitiator in a proportion of 0.01 to 7 wt-%;
(C) 0.001-3 wt-%, preferably 0.01-0.1 wt-% of the sterically hindered phenol, and 0 to 5 wt-% of another stabilizer;
(D) 0.01-10 wt-%, preferably 0.05-5 wt-% of the synergist based on a carbon allotrope having unsaturated carbon-carbon bonds;
(E) 0-85 wt-%, preferably 1 to 65 wt-% of at least one further additive, preferably at least one further additive from the group of toughness modifiers, colorants, pigments, fluorescents, thixotropic agents, thickeners, stabilizers, antioxidants, plasticizers, tackifiers, catalysts, fillers, flame retardants, desiccants, corrosion inhibitors, inert and reactive diluents, levelling and wetting agents or adhesion promoters;
with the proportions of components (A) to (E) adding up to 100 percent.

7. The composition according to claim 1, wherein the thermosetting composition is present together with an additional reactive resin composition, with the additional reactive resin composition preferably comprising an additional reactive resin selected from the group of epoxy-containing compounds, oxetanes, vinyl ethers and hybrid compounds thereof with (meth)acrylate groups, as well as at least one curing agent and/or at least one cationic polymerization initiator.

8. The composition according to claim 7, wherein the proportion of the thermosetting composition with components (A) to (E) is 10 to 90 wt-% and that the additional reactive resin composition is present in a proportion of 10 to 90 wt-%, based on the total weight of the mixture of the thermosetting composition and the additional reactive resin composition.

9. The composition according to claim 7, wherein the additional reactive resin composition comprises the following components:
(F) up to 99.99 wt-%, preferably 92-99.9 wt-% of the additional reactive resin; and
(H) 0.001-8 wt-%, preferably 0.01-5 wt-% and particularly preferably 0.1-3 wt-% of
at least one photolatent or thermally latent acid generator for the cationic
polymerization of the additional reactive resin.

10. The composition according to any of the claim 1, wherein the composition has at least one of the following properties:
a complete curing at a temperature of at most 100° C. within less than 5 min, of at most 90° C. within less than 15 min and of at most 80° C. within less than 30 min,
a processing time at room temperature of at least 72 h, preferably at least 120 h, particularly preferably at least 168 h, and
a compression shear strength after curing at 80° C. for 30 min of more than 8 MPa, preferably more than 10 MPa, particularly preferably more than 15 MPa.

11. A use of the composition according to claim 1 as a sealing, adhesive and/or encapsulant composition.

12. A method using the compositions for the joining, encapsulating or coating of substrates according to claim 9, wherein the method comprises:
a) providing the composition;
b) dosing the composition onto a first substrate;
c) optionally feeding a second substrate to the composition;
d) optionally fixing the composition by irradiation with actinic radiation; and
e) heating the composition and the substrate and/or the substrate composite to a temperature of 60 to 100° C. for 5 to 60 minutes while curing the composition.
